(19) United States
(12) Patent Application Publication
(10) Pub. No.: US 2023/0227167 A1
(43) Pub. Date: Jul. 20, 2023

(54) PARACHUTE AND INFLATABLE ASSEMBLY FOR AIR TAXI

(71) Applicant: GOODRICH CORPORATION, Charlotte, NC (US)

(72) Inventors: VASANT NANDAREDDY, Bangalore (IN); VINAYAK SARASHETTI, Bangalore (IN)

(73) Assignee: GOODRICH CORPORATION, Charlotte, NC (US)

(21) Appl. No.: 17/856,462

(22) Filed: Jul. 1, 2022

(30) Foreign Application Priority Data
Jan. 19, 2022 (IN) 202241003013

(51) Int. Cl. B64D 17/80; B64C 25/56

(52) U.S. Cl. CPC B64D 17/80; B64C 25/56; B64C 27/006

(57) ABSTRACT

A parachute and inflatable assembly for an aircraft may comprise a parachute configured to attach to the aircraft and an inflatable configured to extend from a bottom surface of the aircraft. A propulsion system sensor may be configured to measure an operating condition of a propulsion system and a controller may determine whether the propulsion system is experiencing a failure based on a signal output from the propulsion system sensor.

### CROSS-REFERENCE TO RELATED APPLICATIONS

This application claims priority to, and the benefit of, India Patent Application No. 202241003013, filed Jan. 19, 2022 (DAS Code EF25) and titled “PARACHUTE AND INFLATABLE ASSEMBLY FOR AIR TAXI” which is incorporated by reference herein in its entirety for all purposes.

### BACKGROUND

Urban transportation systems that move people by air, often referred to as urban air mobility or advanced air mobility, are becoming increasingly popular. The aircrafts used for this purpose typically employ a vertical take-off and landing propulsion means, such that the aircraft can take-off and land vertically, thereby avoiding the need for a runway. The aircraft may be controlled by a pilot on the aircraft or via an automatic pilot system, wherein the aircraft is controlled remotely or generally not by anyone located on the aircraft. With the emergence of this new mode of transportation, safety is also a concern. In particular, failure of the aircraft propulsion system is a scenario that needs addressing

### SUMMARY

A parachute and inflatable assembly for an aircraft is disclosed herein. In accordance with various embodiments, the parachute and inflatable assembly may comprise a parachute configured to attach to the aircraft and an inflatable configured to extend from a bottom surface of the aircraft.

In various embodiments, a propulsion system sensor may be configured to measure an operating condition of a propulsion system. In various embodiments, a propulsion system failure alert may be configured to output at least one of a visual alert or an audio alert.

In various embodiments, a controller is in communication with the propulsion system sensor and the propulsion system failure alert. The controller may be configured to command the propulsion system failure alert to output the at least one of the visual alert or the audio alert in response to determining a first signal output by the propulsion system sensor is indicative of a failure of the propulsion system

In various embodiments, an inflatable deployment sensor may be configured to detect a distance between the bottom surface of the aircraft and an impact surface.

In various embodiments, the controller may be configured to receive a second signal from the inflatable deployment sensor. The controller may be configured to deploy the inflatable in response to determining the second signal indicates the distance between the bottom surface of the aircraft and the impact surface is less than a threshold difference.

In various embodiments, a handle may be operably coupled to the parachute, and the parachute may be configured to deploy in response to actuation of the handle.

An aircraft is also disclosed herein. In accordance with various embodiments, the aircraft may comprise a fuselage, a parachute attached to the fuselage, and an inflatable configured to extend away from a bottom surface of the fuselage.

In various embodiments, the aircraft includes a propulsion system, a propulsion system sensor configured to measure an operating condition of the propulsion system, and a controller configured to receive a signal from the propulsion system sensor, the signal corresponding the operating condition of the propulsion system.

In various embodiments, an inflatable deployment sensor may be in communication with the controller. The controller may be configured to send a deploy command to the inflatable in response to the inflatable deployment sensor detecting an impact surface within a threshold distance from the bottom surface of the aircraft.

In various embodiments, a propulsion system failure alert may be located in the cockpit of the fuselage. The controller may be configured to command the propulsion system failure alert to output at least one of a visual alert or an audio alert in response to determining the signal from the propulsion system sensor is indicative of a failure of the propulsion system.

In various embodiments, a handle may be located in the cockpit of the fuselage, and the parachute may be configured to deploy in response to actuation of the handle. In various embodiments, actuation of the handle may activate the inflatable deployment sensor.

In various embodiments, the controller may be configured to deploy the parachute in response to determining that the signal from the propulsion system sensor indicates a thrust of the propulsion system is less than a threshold thrust.

In various embodiments, the inflatable may define a sliding surface. In various embodiments, the inflatable may be configured to function as a life raft.

An article of manufacture including a tangible, non-transitory computer-readable storage medium having instructions stored thereon for controlling a parachute and inflatable assembly located on an aircraft having a propulsion system configured for vertical take-off and landing is also disclosed herein. In accordance with various embodiments, the instructions, in response to execution by a controller, cause the controller to perform operations, which may comprise receiving, by the controller, a first signal corresponding to an operating condition of the propulsion system from a propulsion system sensor; determining, by the controller, whether the first signal indicates a failure of the propulsion system is experiencing; and commanding, by the controller, a propulsion system failure alert to output at least one of a visual alert or an audio alert in response to determining the first signal indicates the failure of the propulsion system.

In various embodiments, wherein the operations may further comprise receiving, by the controller, a second signal from an inflatable deployment sensor; determining, by the controller, a distance between the aircraft and an impact surface based on the second signal; and outputting, by the controller, a deploy signal to the inflatable in response to determining the distance between the aircraft and the impact surface being less than a threshold difference.

In various embodiments, the operations may further comprise activating, by the controller, the inflatable deployment sensor in response to determining the first signal from by the propulsion system sensor indicates the failure of the propulsion system.

In various embodiments, the operations may further comprise outputting, by the controller, a deploy signal to the parachute in response to determining the first signal from the propulsion system sensor indicates the failure of the propulsion system.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 illustrates a starboard side view of an aircraft having a parachute and inflatable assembly, with the parachute and inflatable assembly in a stowed state, in accordance with various embodiments;

FIG. 2 illustrates a schematic of an aircraft parachute and inflatable assembly, in accordance with various embodiments;

FIGS. 3A and 3B illustrate a starboard side view and a front view, respectively, of an aircraft having a parachute and inflatable assembly, with the parachute and inflatable assembly in a deployed state, in accordance with various embodiments; and

FIGS. 4A and 4B illustrate an inflatable, of a parachute and inflatable assembly, in the deployed state, in accordance with various embodiments.

Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to tacked, attached, fixed, coupled, connected or the like may include permanent, removable, temporary, partial, full and/or any other possible attachment option. Additionally, any reference to without contact (or similar phrases) may also include reduced contact or minimal contact. Surface shading lines may be used throughout the figures to denote different parts but not necessarily to denote the same or different materials.

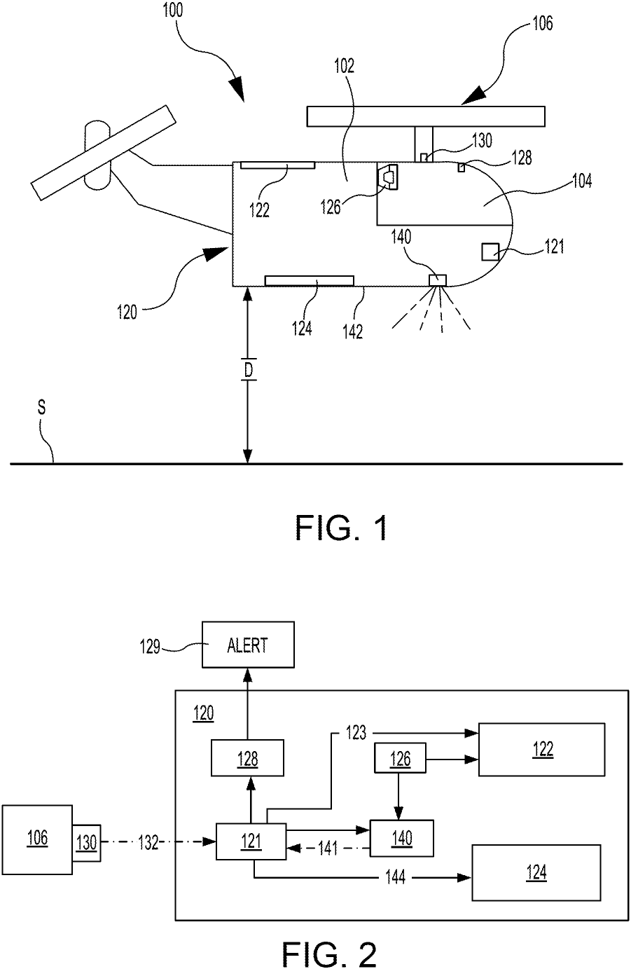

With reference to FIG. 1, an aircraft 100 is shown, in accordance with various embodiments. Aircraft 100 includes a fuselage 102 having a cockpit 104 in which passengers and/or a pilot of aircraft 100 are seated during flight. In various embodiments, aircraft 100 is controlled by a person (e.g., pilot) seated in cockpit 104. In various embodiments, aircraft 100 may be controlled remotely (e.g., with no pilot in the cockpit 104, but with passengers being transported by the aircraft 100). For example, aircraft 100 may be controlled by an autopilot system and/or by a person or system located remotely from aircraft (e.g., located on the ground and/or at an offsite ground control location).

Aircraft 100 includes a propulsion system 106. Propulsion system 106 is configured to allow for vertical take-off and vertical landing of aircraft 100. While propulsion system 106 is illustrated as including a main rotor attached at a roof of fuselage 102 and a tail rotor attached at a tail boom of aircraft 100, it is contemplated and understood that propulsion system 106 may include other rotor configurations that allow for vertical take-off and landing of aircraft 100. In this regard, propulsion system 106 may include any number of rotors at any location(s) that allows the propulsion system 106 to generate vertical take-off and landing of aircraft 100.

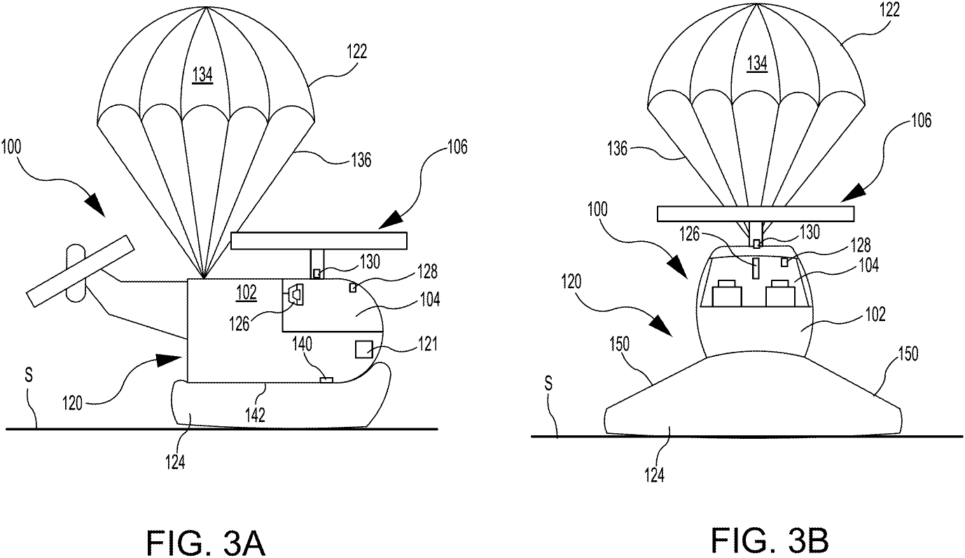

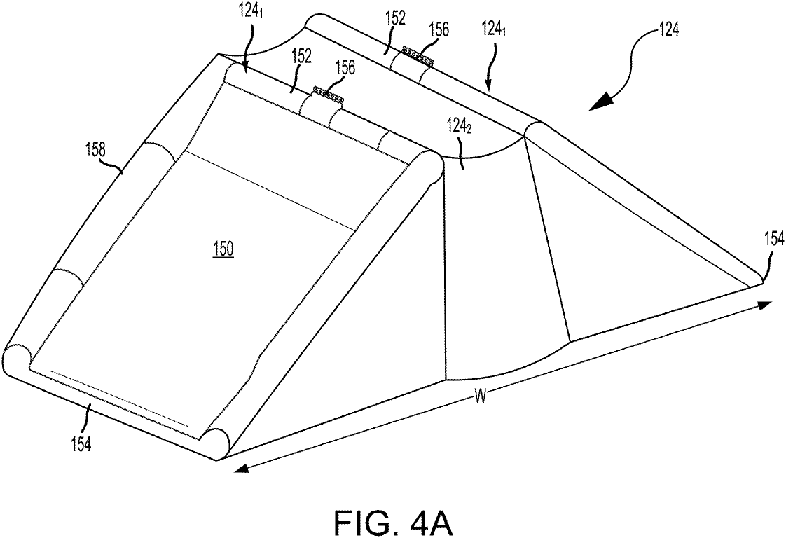

In accordance with various embodiments, aircraft 100 includes a parachute and inflatable assembly 120. Stated differently, parachute and inflatable assembly 120 is installed on aircraft 100. Parachute and inflatable assembly 120 includes a parachute 122 and an inflatable 124. FIG. 1 shows parachute 122 and inflatable 124 in the stowed state. FIG. 2 shows a schematic representation of parachute and inflatable assembly 120. FIGS. 3A and 3B show parachute 122 and inflatable 124 in the deployed stated.

With combined reference to FIGS. 1, 2, 3A, and 3B, in accordance with various embodiments, parachute and inflatable assembly 120 may be configured to deploy in response to actuation of a handle 126 located in cockpit 104. Handle 126 may be actuated by the passenger(s) and/or crew of aircraft 100. While the deployment of parachute and inflatable assembly 120 is described as occurring in response to actuation of handle 126, it is contemplated and understood that other deployment means may be employed by parachute and inflatable assembly 120. For example, deployment of parachute and inflatable assembly 120 may occur in response to depression of a button, actuation of a lever, tapping of a touch screen, etc. by a passenger or crew member of aircraft 100. In various embodiments, parachute and inflatable assembly 120 may be deployed remotely (e.g., by a person or system located off aircraft 100). In various embodiments, parachute and inflatable assembly 120 deploys automatically. For example, a controller 121 may be configured to deploy parachute 122 and/or inflatable 124 of parachute and inflatable assembly 120 if propulsion system 106 is experiencing a failure (e.g., the thrust being produced by propulsion system 106 is less than a threshold thrust) and/or an altitude of aircraft 100 is less than a threshold altitude and/or the altitude of aircraft 100 is decreasing at a rate greater than a threshold rate. In various embodiments, controller 121 may deploy parachute 122 in response to failure of propulsion system 106 and inflatable 124 in response to the altitude of aircraft 100 being less than a threshold level.

Controller 121 may include a general-purpose processor, a digital signal processor (DSP), an application specific integrated circuit (ASIC), a field programmable gate array (FPGA), or some other programmable logic device, discrete gate or transistor logic, discrete hardware components, or any combination thereof. A tangible, non-transitory computer-readable storage medium is in communication with controller 121. The storage medium may comprise any tangible, non-transitory computer-readable storage medium known in the art. The storage medium has instructions stored thereon that, in response to execution by controller 121 cause controller 121 to perform operations related to controlling parachute and inflatable assembly 120.

Parachute and inflatable assembly 120 includes a propulsion system failure alert 128. Propulsion system failure alert 128 is configured to output an alert 129. Alert 129 is configured to alert the passenger(s) or crew of aircraft 100 that propulsion system 106 is experiencing a failure (e.g., is not generating sufficient propulsion to keep aircraft 100 in the air) and that parachute and inflatable assembly 120 should be deployed. Alert 129 may be a visual alert (e.g., a flashing light, a text message on a screen, etc.), an audio alert (e.g., an alarm, a verbal message output by a speaker, etc.), and/or any other alert configured to convey to the passenger(s) and/or crew of aircraft 100 that parachute and inflatable assembly 120 should be deployed.

In various embodiments, controller 121 is in communication with propulsion system failure alert 128 and a propulsion system sensor 130. Propulsion system sensor 130 is operably coupled to propulsion system 106. Propulsion system sensor 130 is configured to measure at least one operating condition of propulsion system 106. For example, propulsion system sensor 130 may measure a rotor speed, a thrust, and/or any other operating condition that may be indicative of the health of propulsion system 106. Controller 121 is configured to receive a signal 132, indicative of the operating condition of propulsion system 106, from propulsion system sensor 130. Controller 121 is configured to determine whether propulsion system 106 is experiencing a failure based on signal 132. Controller 121 is configured to command propulsion system failure alert 128 to output alert 129 in response to determining that signal 132 indicates a failure of propulsion system 106. In various embodiments, controller 121 may determine whether to initiate deployment of the parachute and inflatable assembly 120 based on signal 132.

In accordance with various embodiments, parachute 122 is configured to deploy in response to deployment of parachute and inflatable assembly 120. For example, in various embodiments, parachute 122 deploys in response to actuation of handle 126. In various embodiments, controller 121 may be configured to deploy parachute 122. For example, controller 121 may send a deploy command 123 to parachute 122, if signal 132 indicates failure of propulsion system 106 and the altitude of aircraft 100 is less than a threshold altitude. The altitude being less than a threshold altitude may be indicative that the passenger/crew have failed to actuate the handle 126 and/or that there is not sufficient time to allow the passengers/crew to decide whether to actuate handle 126. In various embodiments, controller 121 may be configured to send deploy command 123 in response to determining signal 132 indicates failure of propulsion system 106 (e.g., controller 121 may deploy parachute 122 automatically upon failure of propulsion system 106).

Parachute 122 includes a canopy 134 (FIGS. 3A and 3B) and a plurality of suspension lines 136 (FIGS. 3A and 3B) attaching canopy 134 to aircraft 100. Upon deployment, canopy 134 tends to decelerate and stabilize aircraft 100 as aircraft 100 travels toward impact surface S. While parachute and inflatable assembly 120 is illustrated as having one parachute 122 attached to aircraft 100, it is contemplated and understood that parachute and inflatable assembly 120 may include any number of parachutes 122 coupled to aircraft 100 at any number of locations.

Parachute and inflatable assembly 120 includes an inflatable deployment sensor 140. In various embodiments, inflatable deployment sensor 140 may be activated (e.g., power ON) in response to deployment of parachute and inflatable assembly 120. For example, in various embodiments, inflatable deployment sensor 140 may be powered ON, in response to actuation of handle 126. Stated differently, inflatable deployment sensor 140 may be operably coupled to handle 126 such that actuation of handle 126 activates inflatable deployment sensor 140. In various embodiments, controller 121 may activate inflatable deployment sensor 140 in response to determining that signal 132 indicates a failure of propulsion system 106. In this regard, controller 121 may provide a redundancy to activate inflatable deployment sensor 140 should a passenger/crew member fail to actuate handle 126. Inflatable deployment sensor 140 is configured to measure a distance D (FIG. 1) between aircraft 100 and an impact surface S. Impact surface S may be a ground surface, a body of water, or any surface or object which is in the landing path of aircraft 100. Inflatable deployment sensor 140 may be a proximity sensor, an altitude sensor, and/or any other sensor capable of detecting an object/surface within a threshold distance of aircraft 100. Inflatable 124 is configured to deploy in response to inflatable deployment sensor 140 detecting that impact surface S is within the threshold distance from aircraft 100. In this regard, controller 121 may be configured to output a deploy signal 144 to inflatable 124 based on a signal 141 received from inflatable deployment sensor 140.

In various embodiments, the signal 141 output by inflatable deployment sensor 140 is indicative of distance D. Controller 121 may be configured to output deploy signal 144 in response to signal 141 indicating a surface and/or object is within the threshold distance from aircraft 100. In various embodiments, inflatable deployment sensor 140 may be, for example, an altitude sensor, and may active (e.g., be powered ON and outputting signal 141) during normal flight conditions. In this regard, in various embodiments, controller 121 may be configured to deploy inflatable 124 only when signal 132 indicates propulsion system 106 failure and signal 141 indicates impact surface S is within the threshold distance from aircraft 100. Stated differently, inflatable 124 deploys only in response to the combination of propulsion system failure and distance D (FIG. 1) being less than or equal to the threshold distance. Controller 121 may be configured to deploy inflatable 124 when aircraft 100 is, for example, 200 meters from impact surface S, 100 meters from impact surface S, 50 meters from impact surface S, or any distance that allows inflatable 124 to fully inflate prior to contact with impact surface S.

Referring now specifically to FIGS. 3A and 3B, in various embodiments, inflatable 124 may deploy and/or extend from a bottom surface 142 of aircraft 100. Bottom surface 142 is the surface of aircraft 100 that is oriented toward the impact surface S when parachute 122 is deployed. In this regard, parachute 122 may orient bottom surface 142 toward impact surface S. In various embodiments, bottom surface 142 is oriented toward the ground prior to take-off of aircraft 100. Inflatable 124 is configured such that, in the inflated state, inflatable 124 contacts impact surface S prior to any other component of aircraft 100. In this regard, inflatable 124 is located between impact surface S and aircraft 100. Stated differently, in the deployed state, bottom surface 142 is located on inflatable 124 with fuselage 102 located between inflatable 124 and the attachment point of suspension lines 136. In the inflated state, inflatable 124 contacts impact surface S prior to bottom surface 142 and/or prior to any landing skis or landing gear extending from bottom surface 142.

In the deployed (i.e., inflated) state, inflatable 124 attenuates and/or reduces the impact force generated by contact with impact surface S. Thus, deployment of parachute 122 decreases the velocity of aircraft 100 and deployment of inflatable 124 decreases the force at impact with impact surface S. In this regard, parachute and inflatable assembly 120 increases safety and/or reduces the chances for injury to the passengers and/or crew of aircraft 100.

In various embodiments, inflatable 124 may also create a sliding surface 150 to safely convey passengers and/or crew of aircraft 100 to impact surface S. For example, inflatable 124 may increase a height of the door sill of aircraft 100 (i.e., a distance between door sill and impact surface S) such that exiting the aircraft 100 from the door sill poses a chance for injury. Inflatable 124 providing a sliding surface 150 for the passengers and/or crew allows the passengers or crew to exit aircraft 100 by entering sliding surface 150. Providing a sliding surface 150 decreases the chances for injury during evacuation from aircraft 100. In various embodiments, inflatable 124 may also function as a life-raft in the event of a water landing.

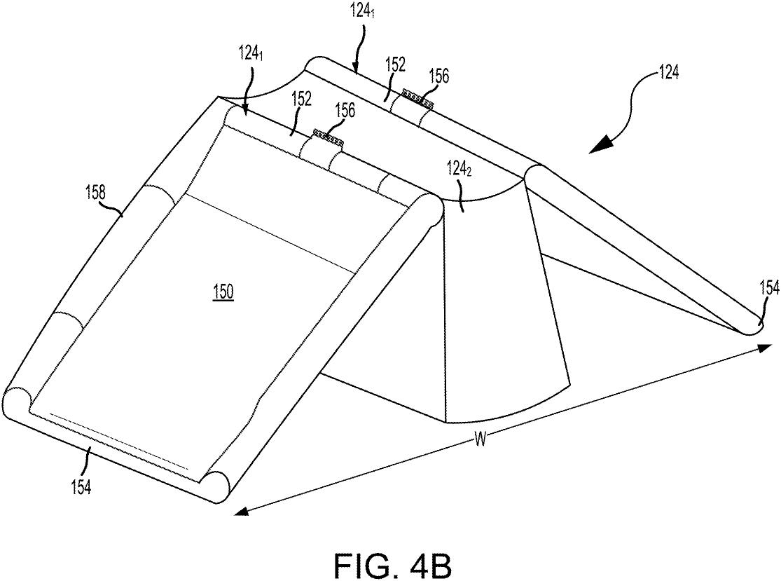

With reference to FIG. 4A, a slide portion 124₁ of inflatable 124 is illustrated. Slide portion 124₁ may define sliding surface 150. In various embodiments, inflatable 124 may include a slide portion 124₁ proximate each of the exit door(s) of the aircraft (e.g., a slide portion 124₁ may be located at each of the port side door, starboard side door, cockpit door, etc.) and an underside portion(s) 124₂ directly under bottom surface 142 (FIG. 3A). In various embodiments, the underside portion(s) 124₂ of inflatable 124 may contact bottom surface 142. In various embodiments, slide portions 124₁ may be located along opposing sides of underside portion 124₂. Stated differently, a first slide portion 124₁ may extend from a first side of underside portion 124₂ and a second slide portion 124₁, which is similar to the first side portion shown in FIG. 4A, may extend from a second, opposing siding of underside portion 124₂.

Slide portion(s) 124₁ include(s) a head end 152 and a toe end 154. Head end 152 may be coupled to an aircraft structure (e.g., a door frame of fuselage 102) via a girt 156. Toe end 154 may contact an exit surface (e.g., the ground or the water). Sliding surface 150 extends from head end 152 to toe end 154. In various embodiments, sliding surface 150 may be bounded, at least partially, by an inflatable siderail structure 158. In various embodiments, inflatable siderail structure 158 may be fluidly separate from the other portions of inflatable 124. For example, inflatable siderail structure 158 may form one, interconnected chamber that fills with gas upon deployment of inflatable 124 and the other portion(s) of inflatable 124 (e.g., underside portion 124₂ and/or other portions of slide portion 124₁) may form one or more separate chamber(s) that is/are fluidly sealed from the inflatable siderail structure 158. In various embodiments, inflatable siderail structure 158 may be fluidly connected to the other portions of inflatable 124 (e.g., to the underside portion 124₂). In this regard, inflatable 124, including inflatable siderail structure 158, may be one, interconnected chamber that fills with gas upon deployment of inflatable 124. fluid communication.

With reference to FIG. 4B, in various embodiments, slide portion 124₁ may be configured to be uncoupled from the aircraft structure such that slide portion 124₁ can serve as a life raft in the event of a water landing. In this regard, slide portion 124₁ may be distinct and/or separable from other portions of inflatable 124 (e.g., from underside portion 124₂). In the inflated state, slide portions 124₁ extend beyond the width of fuselage 102. In this regard, a width W of inflatable 124, as measured at the toe ends 154 of slide portions 124₁ (e.g., as measured at the point where inflatable 124 contacts the exit surface) may be wider than fuselage 102 and/or may be the widest point on inflatable 124.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosures is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A parachute and inflatable assembly for an aircraft, comprising:
a parachute configured to attach to the aircraft; and
an inflatable configured to extend from a bottom surface of the aircraft.

2. The parachute and inflatable assembly of claim 1, further comprising a propulsion system sensor configured to measure an operating condition of a propulsion system.

3. The parachute and inflatable assembly of claim 2, a propulsion system failure alert configured to output at least one of a visual alert or an audio alert.

4. The parachute and inflatable assembly of claim 3, a controller in communication with the propulsion system sensor and the propulsion system failure alert, wherein the controller is configured to command the propulsion system failure alert to output the at least one of the visual alert or the audio alert in response to determining a first signal output by the propulsion system sensor is indicative of a failure of the propulsion system.

5. The parachute and inflatable assembly of claim 4, further comprising an inflatable deployment sensor configured to detect a distance between the bottom surface of the aircraft and an impact surface.

6. The parachute and inflatable assembly of claim 5, wherein the controller is configured to receive a second signal from the inflatable deployment sensor, and wherein the controller is configured to deploy the inflatable in response to determining the second signal indicates the distance between the bottom surface of the aircraft and the impact surface is less than a threshold difference.

7. The parachute and inflatable assembly of claim 5, further comprising a handle operably coupled to the parachute, wherein the parachute is configured to deploy in response to an actuation of the handle, and wherein the actuation of the handle is configured to activate the inflatable deployment sensor.

8. The parachute and inflatable assembly of claim 1, wherein the inflatable defines a sliding surface extending from a head end of the inflatable to a toe end of the inflatable.

9. An aircraft, comprising:
a fuselage;
a parachute attached to the fuselage; and
an inflatable configured to extend away from a bottom surface of the fuselage, wherein the inflatable defines a sliding surface.

10. The aircraft of claim 9, further comprising:
a propulsion system;
a propulsion system sensor configured to measure an operating condition of the propulsion system; and
a controller configured to receive a signal from the propulsion system sensor, the signal corresponding the operating condition of the propulsion system.

11. The aircraft of claim 10, further comprising an inflatable deployment sensor in communication with the controller, wherein the controller is configured to send a deploy command to the inflatable in response to the inflatable deployment sensor detecting an impact surface within a threshold distance from the bottom surface of the aircraft.

12. The aircraft of claim 11, further comprising a propulsion system failure alert located in a cockpit of the fuselage, wherein the controller is configured to command the propulsion system failure alert to output at least one of a visual alert or an audio alert in response to determining the signal from the propulsion system sensor is indicative of a failure of the propulsion system.

13. The aircraft of claim 12, further comprising a handle located in the cockpit of the fuselage, wherein the parachute is configured to deploy in response to an actuation of the handle.

14. The aircraft of claim 13, wherein the actuation of the handle activates the inflatable deployment sensor.

15. The aircraft of claim 10, wherein the controller is configured to deploy the parachute in response to determining that the signal from the propulsion system sensor indicates a thrust of the propulsion system is less than a threshold thrust.

16. The aircraft of claim 9, wherein at least a portion of the inflatable is configured to function as a life raft.

17. The aircraft of claim 16, wherein the portion of the inflatable that is configured to function as the life raft is detachably coupled to the fuselage.

18. An article of manufacture including a tangible, non-transitory computer-readable storage medium having instructions stored thereon for controlling a parachute and inflatable assembly located on an aircraft having a propulsion system configured for vertical take-off and landing, the instructions, in response to execution by a controller, cause the controller to perform operations comprising:
receiving, by the controller, a first signal from a propulsion system sensor, the first signal corresponding to an operating condition of the propulsion system;
determining, by the controller, whether the first signal indicates a failure of the propulsion system; and
commanding, by the controller, a propulsion system failure alert to output at least one of a visual alert or an audio alert in response to determining the first signal indicates the failure of the propulsion system.

19. The article of claim 18, wherein the operations further comprise:
receiving, by the controller, a second signal from an inflatable deployment sensor;
determining, by the controller, a distance between the aircraft and an impact surface based on the second signal; and
outputting, by the controller, a deploy signal to the inflatable in response to determining the distance between the aircraft and the impact surface being less than a threshold difference.

20. The parachute and inflatable assembly of claim 19, wherein the inflatable defines a sliding surface.
